(19) United States
(12) Patent Application Publication
(10) Pub. No.: US 2012/0104926 A1
(43) Pub. Date: May 3, 2012

(54) SPARK PLUG, PARTICULARLY FOR A STATIONARY INTERNAL COMBUSTION ENGINE

(76) Inventors: Detlef Hartmann, Bamberg (DE); Hermann Kersting, Ludwigsburg (DE); Lars Menken, Donzdorf (DE); Dirk Scholz, Fellbach (DE); Mario Fleischhauer, Poedeldorf (DE); Karl Linhardt, Buttenheim (DE); Christian Wenzl, Muenchen (DE)

(21) Appl. No.: 13/122,685

(22) PCT Filed: Sep. 8, 2009
(86) PCT No.: PCT/EP2009/061626

§ 371 Date: Oct. 12, 2011

(30) Foreign Application Priority Data
Oct. 6, 2008 (DE) 10 2008 042 625.3

(51) Int. Cl. H01T 13/20

(52) U.S. Cl. 313/139

(57) ABSTRACT

A spark plug, especially for a stationary internal combustion engine, is described that includes a ground electrode and a center electrode, the center electrode including an inner area, an outer ring and at least two crosspieces, in which the at least two crosspieces connect the inner area to the outer ring.

### FIELD OF THE INVENTION

The present invention relates to a spark plug, which is designed especially for use in a stationary internal combustion engine.

BACKGROUND INFORMATION

Spark plugs in diversified embodiments are discussed in the related art. In stationary internal combustion engines or rather, in internal combustion engines that run at essentially constant speed, spark plugs have to have as long a service life as possible, since a standstill of such internal combustion engines during a change of spark plugs leads to high costs. For this reason, up to now, center electrodes have been used in such internal combustion engines, which have a crown-like shape, using four crosspieces that lie in the axial direction. A ground electrode is situated, in this instance, at the radial outer end of the crosspieces, beyond the length of the crosspieces. In response to such a geometry, however, a very large, locally erosive stress occurs in the ground electrode. Because of that, the ground electrode has to be made of a noble metal, which makes the overall spark plug very costly.

### SUMMARY OF THE INVENTION

By contrast, the spark plug according to the exemplary embodiments and/or exemplary methods of the present invention, having the features described herein, has the advantage that it may be produced in a simple and cost-effective manner. In particular, no noble metal has to be used for the ground electrode, in this context. This is achieved, according to the exemplary embodiments and/or exemplary methods of the present invention, by the center electrode including an inner area, an outer ring and at least two crosspieces. The crosspieces, in this instance, connect the inner area to the outer ring, so that the center electrode has a plurality of free areas between the inner area and the outer ring. The center electrode is able to be produced particularly simply, for example, by a stamping process or a laser cutting process, in this instance. This significantly reduces the production costs for the entire spark plug, especially since no noble metal is required as the material for the ground electrode. The center electrode may have a symmetrical design, in this context.

The further embodiments described herein show further developments of the present invention.

The inner area of the center electrode may be configured as an inner ring. This requires only a low material requirement for the center electrode. The inner area of the center electrode is alternatively configured as an inner disk. The material requirement for the center electrode is thereby increased only insubstantially, since the inner area has a relatively small outer diameter. The center electrode having an inner disk is, however, fastened more simply, for instance, using laser welding.

Furthermore, the inner area may be configured as an inner ring, and the width of the inner ting is equal to the width of the outer ring. From this, there comes about a particular geometry of the center electrode. Moreover, a width of the crosspiece may be 1.5 times, and further may be twice the width of the inner ring. Thereby, in particular, good heat dissipation may be achieved from the outer ring to the inner area of the ground electrode. The width of the crosspiece may also be 1.5 times, and may be twice the width of the outer ring.

In order to be able to produce the center electrode in a particularly simple and cost-effective manner, the center electrode has a flat, disk-shaped form.

In order to have only slight wear on the center electrode during operation of the spark plug, the outer ring of the center electrode may be made of noble metal. It should be noted at this point that, from a standpoint of production engineering, the entire center electrode may be made of noble metal. It is true that more noble metal is thereby used for the center electrode, but production is significantly more cost-effective.

The center electrode may include exactly three or exactly four or exactly five or exactly six crosspieces. When four crosspieces are used especially, particularly good heat dissipation is able to be achieved from the outer ring in the direction of the inner area, so that the temperature stress of the outer ring is able to be reduced. Using exactly four crosspieces yields an optimum between good heat conduction and a cross sectional area covered by the crosspieces.

In order to achieve a particularly long service life for the spark plug, the thickness of the center electrode may equal to the width of the outer ring. A square cross section of the outer ring is particularly obtained thereby, which is particularly resistant to wear. Furthermore, a square cross section demonstrates a very good ratio between the surface (for heat absorption) and the cross sectional area (for heat dissipation).

Moreover, the ground electrode is configured to be annular, and has a thickness equivalent to the thickness of the center electrode. The ground electrode is situated radially outside the outer ring, in this context.

In order to reduce the ignition voltage requirement of the spark plug, the center electrode may have a non-circular outer circumference, particularly a toothed outer circumference at the outer ring. If the outer circumference is configured to be toothed, the teeth may be provided in such a way that they taper to a point or that the point is cut off, so that the teeth have a frustoconical shape. Alternatively, the outer circumference of the center electrode may also be milled.

The spark plug according to the exemplary embodiments and/or exemplary methods of the present invention may be used in stationary internal combustion engines or in internal combustion engines that are operated at constant speed. In this connection, the spark plugs may have an anterior chamber, in which the ground electrode and the center electrode are situated. The anterior chamber has one or more channels that produce a connection between the anterior chamber and a combustion chamber of the internal combustion engine. The use of an anterior chamber, in connection with a cart-wheel-like center electrode, having a plurality of crosspieces, makes possible a practically infinite number of spark gaps, so that no special alignment of the channels with respect to the electrodes has to be undertaken.

Exemplary embodiments of the present invention are described in detail below, with reference to FIGS. 1 through 5.

### BRIEF DESCRIPTION OF THE DRAWINGS

FIG. 1 shows a schematic, partially sectioned view of a spark plug according to a first exemplary embodiment of the present invention.

FIG. 2 shows a view of a cross section along line II-II in FIG. 1.

FIG. 3 shows an enlarged, sectional partial view of the spark plug shown in FIG. 1.

FIG. 4 shows a schematic lateral view of a center electrode for a spark plug, according to a second exemplary embodiment of the present invention.

FIG. 5 shows a schematic top view of the center electrode of the second exemplary embodiment, shown in FIG. 4.

### DETAILED DESCRIPTION

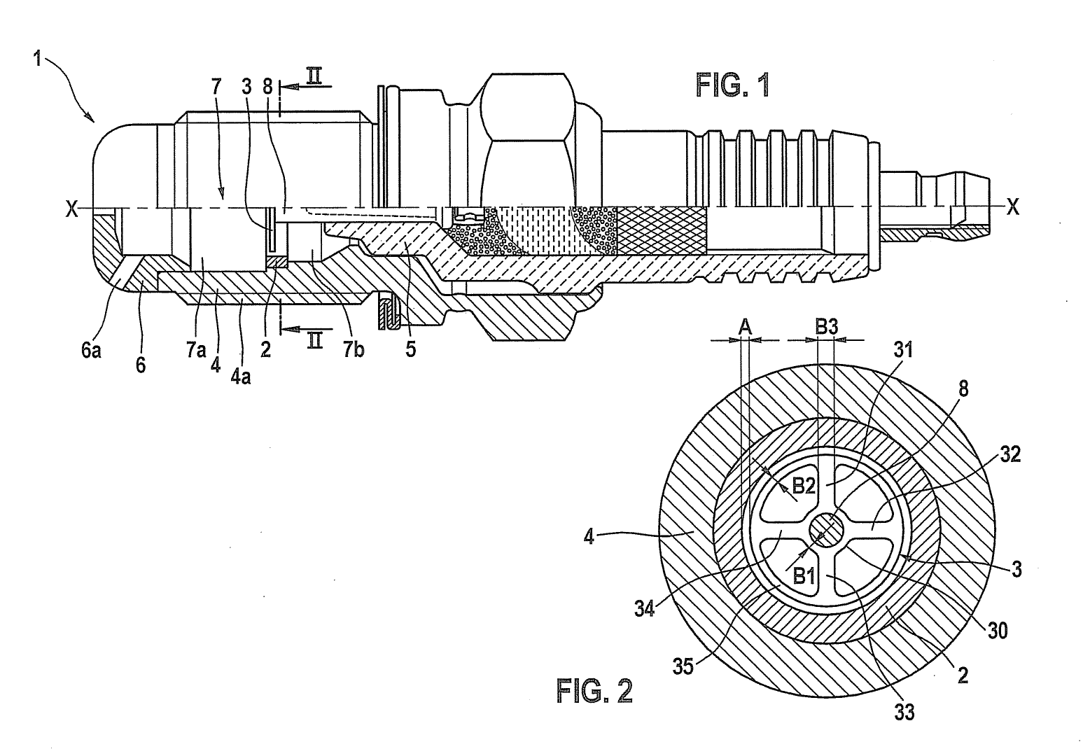

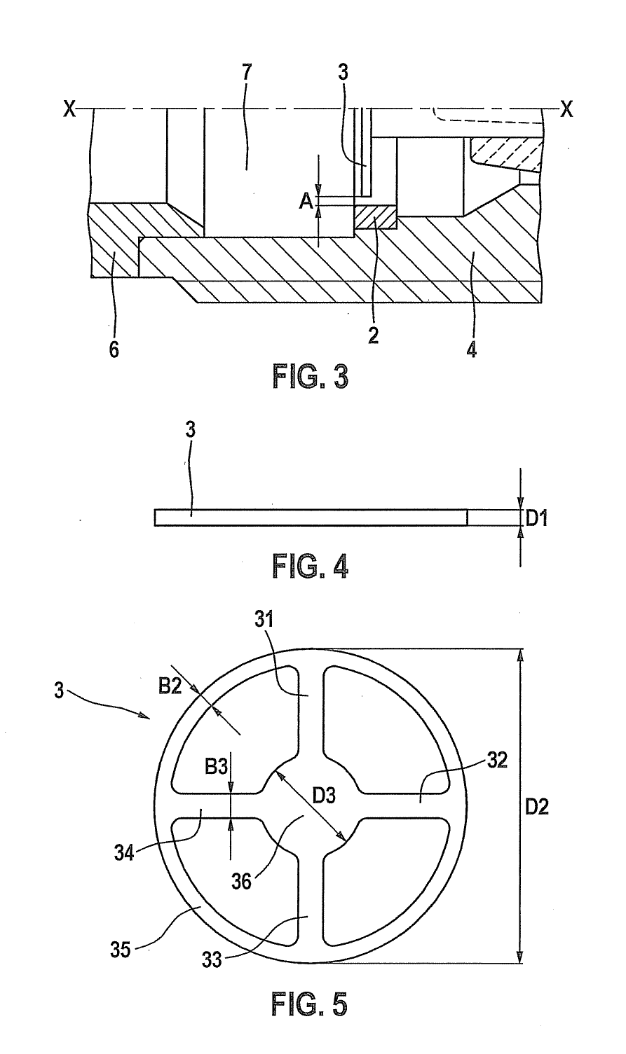

With reference to FIGS. 1 to 3, a spark plug 1 according to a first exemplary embodiment of the present invention is described in detail below.

As may be seen in FIG. 1, spark plug 1 includes a ground electrode 2, a center electrode 3, a housing 4 and an insulator 5. Spark plug 1 of this exemplary embodiment is designed for a stationary internal combustion engine, and it also includes an anterior chamber 6, which is defined by the end of housing 4 on the combustion chamber end, as well as a set-on part 6 fastened to housing 4. On set-on part 6, four channels 6a are configured to provide a connection to the combustion chamber of the internal combustion engine. As may be seen in FIG. 1, anterior chamber 7 has a volume 7a on its combustion chamber end and a volume 7b facing away from the combustion chamber, volume 7b, that is facing away from the combustion chamber, lying on the side of center electrode 3 facing away from the combustion chamber. On housing 4 an outer thread 4a is also provided, for screwing the spark plug into a cylinder head, or the like, in a known manner. Additional known parts of the spark plug are not annotated for reasons of clarity.

FIG. 2 shows center electrode 3 in detail. Center electrode 3 has a flat, disk-shaped form and has a wagon wheel-like shape. Center electrode 3 includes an inner ring 30, an outer ring 35 as well as four crosspieces 31, 32, 33, 34. The crosspieces connect inner ring 30 with outer ring 35, in this context. Crosspieces 31, 32, 33, 34 are situated at a separation of 90° from one another, so that center electrode 3 has a symmetrical shape.

Inner ring 30 has a width B1, in this instance, which is equal to the width B2 of outer ring 35. Furthermore, crosspieces 31, 32, 33, 34 each have a width B3, which is twice as big as width B1 and B2 of the inner ring and outer ring, respectively. This ensures in particular a superb thermal conductive property of center electrode 3, so that damage due to temperature may be avoided on outer ring 35. As may be seen in FIGS. 1 and 2, ground electrode 2 is positioned in a ring-shaped manner in the radial direction from outer ring 35 about center electrode 3 at a distance A, ground electrode 2, in section, having a rectangular cross section. Let it be noted that end set-on part 6 is also able to be used alternatively as ground electrode, if it reaches up to the center electrode.

Reference numeral 8 designates an electrically conductive element, to which center electrode 3 is fastened, for instance, by laser welding. The longitudinal axis of spark, plug 1 is denoted by X-X.

Because of the flat, wagon wheel-like development of center electrode 3, according to the exemplary embodiments and/or exemplary methods of the present invention, it is possible to provide a spark plug which has a particularly long service life. This service life may be additionally prolonged by using a noble metal as the material for outer ring 35. In particular, according to the exemplary embodiments and/or exemplary methods, of the present invention, the use of noble metal may be omitted in ground electrode 2. This makes the spark plug according to the exemplary embodiments and/or exemplary methods of the present invention very cost-effective. It should also be noted that, in particular, the outer circumference of outer ring 35 may be toothed or milled, in order to reduce the ignition voltage requirement.

With reference to FIGS. 4 and 5, we shall now describe an alternative design of center electrode 3 for a spark plug. As may be seen in FIG. 5, center electrode 3 has a disk-shaped inner area 36, which particularly makes possible a very simple fixing of center electrode 3 to the electrically conductive element (not shown in FIGS. 4 and 5). Moreover, disk-shaped center electrode 3 has a thickness of D1, which is equal to the width B2 of outer ring 35. The outer diameter D2 of outer ring 35, in this instance, is approximately three times the outer diameter D3 of disk-shaped inner area 36. In all other respects this exemplary embodiment is equivalent to the previous exemplary embodiment, so that reference may be made to the description supplied there.

1-13. (canceled)

14. A spark plug, for a stationary internal combustion engine, comprising:
a ground electrode; and
a center electrode;
wherein the center electrode includes an inner area, an outer ring and at least two crosspieces, and wherein the at least two crosspieces connect the inner area to the outer ring.

15. The spark plug of claim 14, wherein the inner area is configured as one of an inner ring and an inner disk.

16. The spark plug of claim 14, wherein the inner area is configured as an inner ring and a width of the inner ring is equal to a width of the outer ring.

17. The spark plug of claim 16, wherein a width of the crosspieces is at least 1.5 times as large as the width of the inner ring.

18. The spark plug of claim 14, wherein a width of the crosspieces is at least 1.5 times as large as a width of the outer ring.

19. The spark plug of claim 14, wherein the center electrode is flat and has a constant thickness.

20. The spark plug of claim 14, wherein the outer ring of the center electrode is made of a noble metal.

21. The spark plug of claim 14, wherein the center electrode includes exactly one of:
three crosspieces, four crosspieces, five crosspieces, and six crosspieces.

22. The spark plug of claim 14, wherein a thickness of the center electrode is equal to a width of the outer ring.

23. The spark plug of claim 14, wherein the ground electrode is annular and is situated radially outside the center electrode.

24. The spark plug of claim 14, wherein the outer ring has an irregular outer circumference.

25. The spark plug of claim 14, further comprising:
an anterior chamber, wherein the ground electrode and the center electrode are situated in the anterior chamber, and wherein the anterior chamber has at least one connecting opening for connecting between the anterior chamber and the combustion chamber.

26. The spark plug of claim 16, wherein a width of the crosspieces is at least 2 times as large as the width of the inner ring.

27. The spark plug of claim 14, wherein a width of the crosspieces is at least 2 times as large as a width of the outer ring.

28. The spark plug of claim 14, wherein the outer ring has a toothed outer circumference.

29. A stationary internal combustion engine, comprising:
at least one spark plug, including:
a ground electrode; and
a center electrode;
wherein the center electrode includes an inner area, an outer ring and at least two crosspieces, and wherein the at least two crosspieces connect the inner area to the outer ring.
